(19) United States
(12) Patent Application Publication
(10) Pub. No.: US 2020/0076282 A1
(43) Pub. Date: Mar. 5, 2020

(54) AUTO STATOR WINDING SYSTEM AND METHOD

(71) Applicant: SCHLUMBERGER TECHNOLGY CORPORATION, Sugar Land, TX (US)

(72) Inventors: Min Jin, Singapore (SG); Zhao Wen Pey, Singapore (SG); How Chuang Liew, Shanghai (CN); Teck Hoe Sim, Singapore (SG)

(21) Appl. No.: 16/556,133

(22) Filed: Aug. 29, 2019

(30) Foreign Application Priority Data
Aug. 29, 2018 (SG) 10201807413T

(51) Int. Cl. H02K 15/085; B21F 23/00; B21F 45/00

(52) U.S. Cl. CPC H02K 15/085; B21F 45/00; B21F 23/005

(57) ABSTRACT

An automated technique facilitates winding a stator, such as a stator for a submersible motor of an electric submersible pumping system. According to an embodiment, needles are placed in slots of the stator and a sensor system, e.g. a camera-based vision system, is used to determine the positions of the needles. This data is provided to a control system programmed to assign a predetermined wiring pattern to the needle positions. Based on this predetermined wiring pattern, an automatic feeder system moves a feeder guide into position adjacent the appropriate needles. The automatic feeder system is then operated to feed magnet wire into the corresponding stator slot at the corresponding needle position(s) to achieve a desired winding pattern.

### CROSS REFERENCE TO RELATED APPLICATIONS

This application claims the benefit of Singapore Application No. 10201807413T, filed Aug. 29, 2018, the entirety of which is hereby incorporated herein by reference.

### BACKGROUND

In a variety of electric machines, e.g. motors and generators, relatively long stators are used to create a magnetic field which causes movement of a rotor. An example is a submersible motor of the type used in electric submersible pumping system. The submersible motor tends to have a long stator with longitudinal slots through which magnetic wires are inserted to form the windings which help create the magnetic field. The magnetic wires are inserted by hand to create the windings, and this manual process tends to be slow and labor-intensive. Furthermore, the time involved depends not simply on the length of the motor, which can be up to 10 meters or more, but also on the diameter of the wires and the skill of the operators.

### SUMMARY

In general, a system and methodology provide an automated technique for winding a stator, such as a stator for a submersible motor of an electric submersible pumping system. According to an embodiment, needles are placed in slots of the stator. A sensor system, e.g. a camera-based vision system, is then used to determine the positions of the needles. This data is provided to a control system programmed to assign a predetermined wiring pattern to the needle positions. Based on this predetermined wiring pattern, an automatic feeder system moves a feeder guide into position adjacent the appropriate needle. The automatic feeder system is then operated to feed magnet wire into the corresponding stator slot at the corresponding needle position(s) to achieve a desired winding pattern.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of an electric motor of the type having a relatively long stator, the electric motor being a submersible motor deployed in an electric submersible pumping system, according to an embodiment of the disclosure;

FIG. 2 is a schematic illustration of an example of a stator housing mounted on a fixture during installation of magnetic wire to form the stator windings, according to an embodiment of the disclosure;

FIG. 3 is a schematic end view of an example of a stator housing having slots for receiving the magnetic wire during preparation of the stator windings, according to an embodiment of the disclosure;

FIG. 4 is a top end view illustrating slots of a stator sized for receiving three magnetic wires per slot, according to an embodiment of the disclosure;

FIG. 5 is a top end view illustrating slots of a stator sized for receiving four magnetic wires per slot, according to an embodiment of the disclosure;

FIG. 6 is a top end view illustrating slots of a stator sized for receiving six magnetic wires per slot, according to an embodiment of the disclosure;

FIG. 7 is a schematic illustration of an example of an automated system for installing magnetic wire during preparation of stator windings, according to an embodiment of the disclosure;

FIG. 8 is a schematic illustration of an example of an automated feeder system having a feeder guide for guiding the magnetic wire into the appropriate stator slot, a feeder to automatically feed the wire, and a sensor system, e.g. a camera-based vision system, to enable automatic positioning of the feeder guide, according to an embodiment of the disclosure;

FIG. 9 is an illustration of a camera view obtained by the camera-based vision system to determine needle position and arrangement so as to facilitate positioning of the feeder guide, according to an embodiment of the disclosure;

FIG. 10 is an illustration similar to that in FIG. 8 but showing the automated feeder system in a different operational position, according to an embodiment of the disclosure; and

FIG. 11 is a flowchart illustrating one example of an operational procedure for automatic preparation of the stator windings, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology for automating and thus facilitating preparation of stator windings in, for example, relatively long stators. The relatively long stators may be used in submersible pumping system motors and in other types of electric machines, e.g. electric motors and/or generators. According to an embodiment, the automated technique comprises placing needles in stator slots selected to receive magnetic wire. A sensor system, e.g. a camera-based vision system, is then used to determine the positions of the needles in each slot. This data is provided to a control system which is programmed to assign a predetermined wiring pattern to the needle positions. Based on this predetermined wiring pattern, an automatic feeder system is moved into position adjacent the appropriate needles. The automatic feeder system is then operated to feed magnet wire into the corresponding stator slot at the corresponding needle position(s) to achieve a desired winding pattern.

Generally, the automated system improves process repeatability and product quality. Additionally, the automated system is able to cut down cycle time with respect to winding the entire stator. As a result, human involvement can be minimized while increasing productivity.

During a given stator winding process, magnetic wires are fed back and forth along the slots of the stator in a specific winding pattern. To achieve a high stator slot fill factor, the wires are fitted tightly into the slots and handled with care to avoid damage due to, for example, small bending radii, buckling, or wear during installation.

Generally, the magnetic wire is fed from an end of the stator on a slot by slot basis because insertion of a complete winding from above is generally not possible. Sufficient feeding forces are provided by the automated system so the wire does not get stuck inside the stator housing during winding. Additionally, the fed length of the wire may be controlled so as to obtain short end windings at the ends of the stator.

During the winding process, earlier created end windings may be pushed out of the way, e.g. pushed down, to prevent them from disturbing the winding process by covering unwound the slots. As explained in greater detail below, the feeder guide may have a tapered lead end to facilitate pushing of the end windings to a location that does not interfere with continued winding. To enable winding of different types of stators, the automatic feeder system may be constructed to allow adjustability for accommodating different wire and needle dimensions as well as different winding patterns.

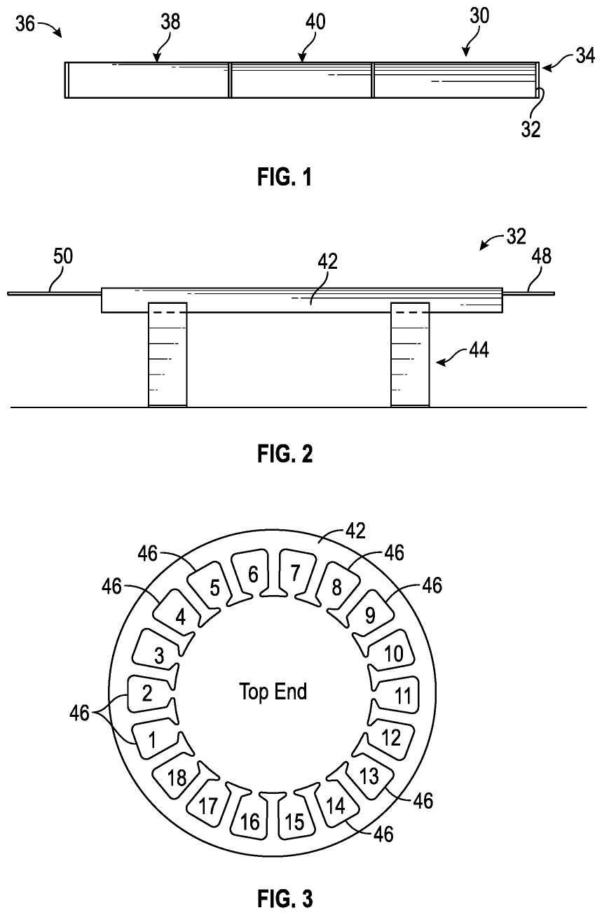

Referring generally to FIG. 1, an example of an electric machine 30 is illustrated and includes a stator 32. In the specific example illustrated, the electric machine 30 is in the form of a submersible motor 34 used in an electric submersible pumping system 36 having additional components, such as a submersible pump 38 and a motor protector 40. It should be noted the electric machine 30 may comprise a variety of motor types and generator types which utilize various forms of stator 32.

In FIG. 2, a stator housing 42 of the type used to form stator 32 is illustrated as mounted in a fixture 44. In various embodiments, the stator housing 42 comprises a certain number of stator slots 46 (see FIG. 3) which are wound with magnetic wire 48. In this manner, the magnetic wire 48 is wound through the stator housing 42 in a predetermined pattern to help create a desired magnetic field. For example, the windings of magnetic wire 48 in the stator 32 of a motor are arranged to help create a desired magnetic field when supplied with electrical energy. The magnetic field causes rotation of an internal rotor (or movement of a linear translator in a linear motor).

During winding of the stator 32, movement of magnetic wire 48 along the appropriate slot 46 (and in the appropriate position within the slot) can be facilitated via corresponding needles 50 pre-positioned in the stator slot 46 or slots 46 being wound (see FIG. 1). The direction of winding and the number of slots 46 can vary substantially depending on the type of motor or generator being constructed. In the example illustrated in FIG. 3, for example, a winding of the magnetic wire 48 may be directed through slot 1 and returned through slot 12 for a predetermined number of times. Similarly, an additional winding of the magnetic wire 48 may be directed through slot 2 and returned through slot 11 for a predetermined number of times. In this example, a winding of the magnetic wire 48 also may be directed through slot 3 and returned through slot 10. A predetermined pattern of winding may be continued until the entire stator housing 42 is wound with the magnet wire or wires 48 in a desired pattern.

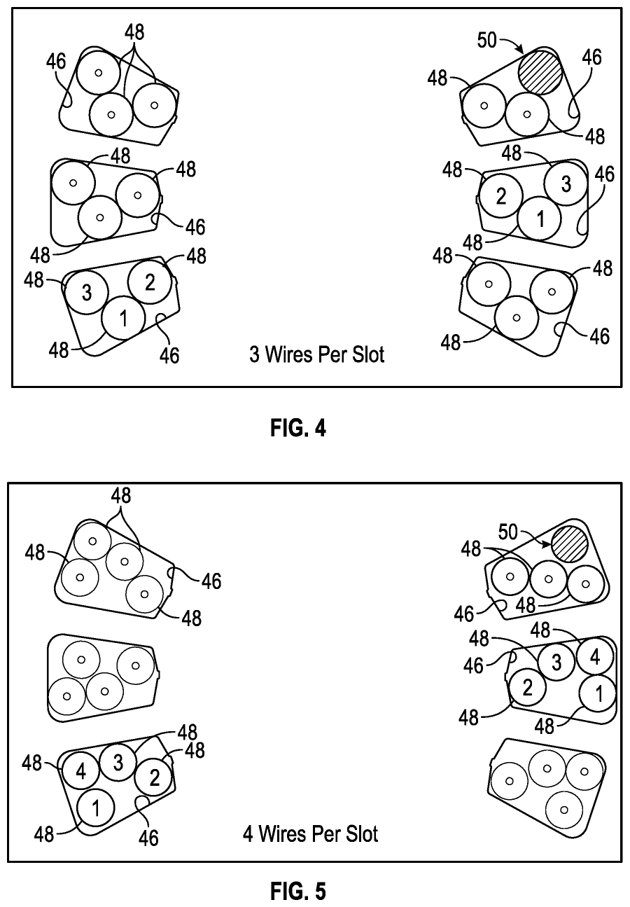

Referring generally to FIGS. 4-6, different examples of slots 46 and wires 48 are illustrated. The number of loops/windings of wire 48 through pairs of slots 46 can vary depending on the size and application of a given electric machine 30, e.g. motor. In FIG. 4, for example, the slots 46 and wires 48 are sized such that each slot 46 contains three sections or wraps of wire 48. Additionally, the wire 48 for each corresponding pair of slots 46 is wrapped in a specific pattern, e.g. see the illustrated 1, 2, 3 pattern. Prior to winding each corresponding pair of slots 46, the needles 50 are placed in this same pattern to accommodate proper positioning of the wire 48 as each wrap/section of wire 48 is pushed along the interior of the corresponding slot 46. In FIG. 4, one remaining needle 50 is illustrated as positioned in one of the slots 46.

In FIG. 5, another example is illustrated in which the slots 46 and wires 48 are sized such that each slot 46 contains four sections of wire 48. The wire 48 for each corresponding pair of slots 46 is similarly wrapped in a specific pattern, e.g. see the illustrated 1, 2, 3, 4 pattern. Prior to winding each corresponding pair of slots 46, needles 50 are placed in this same pattern to accommodate proper positioning of the wire 48 as each wrap/section of the wire 48 is pushed along the interior of the corresponding slot 46. In FIG. 5, one remaining needle 50 is again illustrated as positioned in one of the slots 46.

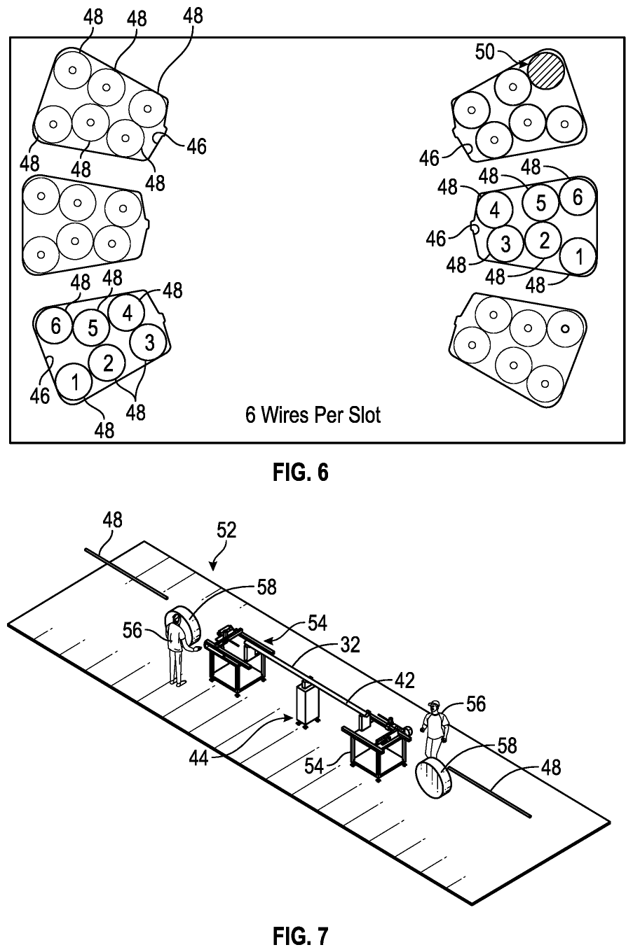

In FIG. 6, another example is illustrated in which the slots 46 and wires 48 are sized such that each slot 46 contains six sections of wire 48. The wire 48 for each corresponding pair of slots 46 is similarly wrapped in a specific pattern, e.g. see the illustrated 1, 2, 3, 4, 5, 6 pattern. Prior to winding each corresponding pair of slots 46, the needles 50 are placed in this same pattern to accommodate proper positioning of the wire 48 as each wrap/section of the wire 48 is pushed along the interior of the corresponding slot 46. In FIG. 6, one remaining needle 50 is again illustrated as positioned in one of the slots 46. It should be noted a variety of other wire sizes and numbers of wire wraps/sections may be positioned in each stator slot 46 depending on the design and use of the corresponding electric machine 30.

Referring generally to FIG. 7, an example of an automated system 52 for winding stator housing 42 is illustrated. In this embodiment, the automated system 52 comprises two automated feeder systems 54 with one automated feeder system 54 located on each end of the stator housing 42 being wound with magnet wire 48. Each automated feeder system 54 is constructed to perform as a wire pushing mechanism which is able to automatically push the wire 48 against the appropriate, corresponding needle 50.

The automated feeder system 54 on a given end of stator housing 42 continues to push the wire 48 along the corresponding stator slot 46 until the end of the wire 48 is pushed through the opposite end of the stator housing 42. Once the end of the wire 48 emerges from the stator housing, the end may be caught and then returned through the corresponding slot 46 via the automated feeder system 54 positioned on that end of the stator housing 42. In some operations, one or more human operators 56, e.g. technicians, may be employed to facilitate the winding process.

According to an operational example, the wire winding begins as one technician 56 picks up an end of the wire 48. By way of example, a wire transfer drum 58 may be equipped to hold the wire 48 and to provide the wire 48 for the corresponding automated feeder system 54. The wire 48 is introduced into the appropriate automated feeder system 54 by the technician. Then, the automated feeder system 54 aligns the wire 48 with the appropriate needle 50 and feeds the wire 48 through the corresponding slot 46 of the stator housing 42.

The wire 48 is pushed against the appropriate needle 50 until the end of the wire 48 emerges from the other end of the stator housing 42 and is picked up by, for example, a cooperating pulling mechanism. In some applications, the automated feeder system 54 which is located at the opposite end of the stator housing 42 may be used as a pulling mechanism. However, other types of pulling mechanisms may be used or the pulling mechanism may be omitted in some operations.

A technician then provides the end of the wire to the automated feeder system 54 located at the opposite end of the stator housing 42 so that the wire 48 may be automatically fed back through the stator housing 42 at the appropriate position within the corresponding slot 46 (with the aid of a corresponding needle 50). The wire is automatically fed back and forth through the corresponding slots 46 in this manner until the entire wire 48 is wound. Subsequently, the automated feeder systems 54 may be used according to the same method to wind the next pair of corresponding slots 46. This process is repeated until winding of the entire stator 32 is completed.

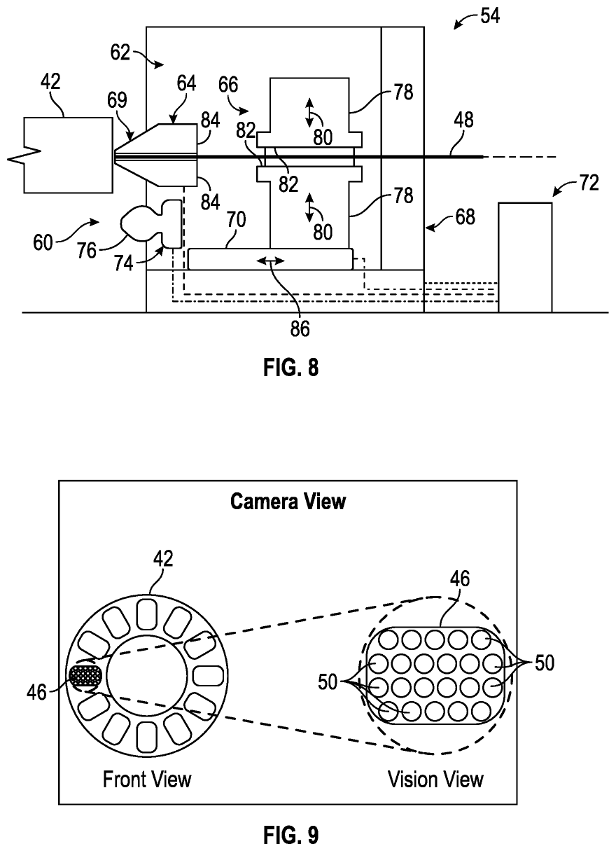

Referring generally to FIG. 8, an example of one of the automated feeder systems 54 is illustrated. In this embodiment, the automated feeder system 54 comprises a sensor system 60, e.g. a camera-based vision system, and an auto feeder 62 having a feeder guide 64 and a feeder 66. The auto feeder 62 may be mounted on a positioning system 68 which is controllable to move the feeder guide 64 and the feeder 66 into desired positions adjacent corresponding needles 50 for feeding of the wire 48. It should be noted the feeder guide 64 may have a tapered lead end 69 to push end windings of wire 48 out of the way, thus avoiding disruption of subsequent winding.

The sensor/camera system 60 also may be mounted on the positioning system 68 or on its own dedicated positioning system to enable movement of the sensor system 60 into and out of position with respect to the end of stator housing 42. By way of example, the positioning system 68 may comprise a three-axis positioning system such as a computer numerical control (CNC) three-axis positioning system. Additionally, the feeder 66 may be mounted on a reciprocation mechanism 70, e.g. a controllable shuttle, to enable back-and-forth motion of the feeder 66 during feeding of wire 48 through feeder guide 64 and into the appropriate slot 46 of stator housing 42.

The sensor/camera system 60, positioning system 68, reciprocating mechanism 70, feeder 66, and feeder guide 64 may be coupled with a suitable control system 72. The control system 72 may be a computer control system or other processor-based control system and, in some applications, may comprise a plurality of cooperating control systems coupled with different components of the automated feeder system 54. The control system 72 may be programmed with suitable algorithms to enable automatic detection of needles 50 via sensor system 60 and subsequent control of the auto feeder 62. For example, based on the needle position data obtained via system 60, the control system 72 is able to instruct the auto feeder 62 to follow a predetermined wire pushing sequence so the wire 48 can push the appropriate needles 50 through the stator housing 42.

In the illustrated embodiment, the sensor system 60 comprises a camera system 74 combined with a lens 76, e.g. a tele-centric lens. The camera system 74 effectively simulates human vision and is able to appropriately detect the positions of needles 50 located in a given slot 46. The camera system 74/sensor system 60 is then able to provide this data to the control system 72 so the auto feeder 62 can insert wire 48 following a predefined sequence. In some applications, the camera system 74 is constructed to detect the centers of individual needles 50.

In FIG. 9, an example of the camera view obtained by camera system 74 is illustrated. In this example, the lens 76 is moved into position adjacent the desired slot 46 at an end of the stator housing 42. The camera system 74 is able to function as a vision system which locates each needle 50, e.g. the center of each needle 50. After identifying the positions of the needles 50 in the corresponding slot 46, the positions are provided to a suitable memory, e.g. a memory of control system 72.

Based on this positioning data, signals are sent to the auto feeder 62 so the feeder guide 64 may be moved into position and feeder 66 may be activated to sequentially will push the wire 48 against each selected needle 50 according to a predefined pattern. An example of software suitable for detecting the centers of the needles 58 and for automatically assigning a winding sequence based on the needle position is LabVIEW software. The control system 72 is programmed to use the assigned winding sequence to instruct the auto feeder 62 to push the wire 48 against appropriate needles 50 according to this predefined sequence (see sequence examples in FIGS. 4-6).

With respect to auto feeder 62, the auto feeder 62 may comprise a variety of components and configurations depending on the parameters of a given stator winding operation. In general, the auto feeder 62 is able: to create and transfer a high enough feeding force to the wire 48; to catch, hold and let go of the wire 48; and to direct the wire 48 straight into the appropriate stator slots 46 without damaging the wire 48. The auto feeder 62 also is constructed to position the wire 48 close enough to the ends of the stator housing 42 without colliding with completed end windings. The auto feeder 62 also is able to position the feeder guide 64 with sufficiently high accuracy so that it can facilitate feeding of the wire straight against a selected needle 50 and into a corresponding slot 46. In some embodiments, the auto feeders 62 may be constructed such that the auto feeder 62 located on the opposite end of the stator housing 42 is able to automatically position itself to catch wire 48 as it is coming out of the slot 46.

The auto feeder 62 also may be constructed to push down end windings which may otherwise be blocking a stator slot 46. The tapered lead end 69 or other suitable structure may be used to clear the end windings. In some embodiments, the auto feeder 62 is adjustable to accommodate, for example, different wire dimensions, different stator sizes, and different stator shapes and winding patterns.

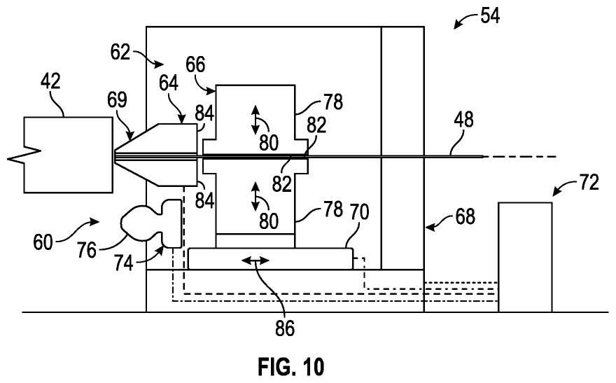

With additional reference to FIG. 10, an embodiment of the auto feeder 62 provides a simple, controllable and compact wire feeder tool able to effectively simulate the motion of a human hand for pushing the wire 48 inside the stator housing 42. The feeder 66 may being motor driven via reciprocation mechanism 70 so as to transfer a desirably high feeding force from the reciprocation mechanism 70 to the wire 48. It should be noted, however, the feeder 66 may comprise or be combined with a variety of reciprocation mechanism 70, such as hydraulically powered or pneumatically powered reciprocation mechanisms 70 controlled via control system 72.

The feeder 66 also may comprise a movable component 78 or components 78 which may be selectively moved away from each other or towards each other as represented by arrows 80 in FIG. 8. Each component 78 comprises a gripping member 82, e.g. an elastomeric gripping member, positioned to grip the wire 48 when the components 78 are closed. By way of example, the gripping members 82 may be constructed from a high-friction rubber having a well-defined radius for receiving the wire 48.

In some embodiments, the feeder guide 64 also may comprise components 84 which may be selectively opened and closed to accommodate insertion of wire 48 during a given winding procedure. Initially, components 78 of feeder 66 are shifted to an open position, as illustrated in FIG. 8, to accommodate loading of wire 48 and insertion of the wire 48 through feeder guide 64. The opening and closing of feeder components 78 (as well as feeder guide components 84) may be achieved via motors, hydraulics, pneumatics, or other suitable techniques, which are controlled via control system 72.

Once the wire 48 is loaded, the feeder components 78 are closed such that gripping members 82 sufficiently grip wire 48, as illustrated in FIG. 10. The feeding force applied to wire 48 may be selected according to the parameters of a given stator winding operation. It should be noted the force for pushing wire 48 against the corresponding needle 50 during a winding procedure can vary substantially from one stator slot 46 to another depending on the position of the wire, small irregularities in the wire diameter, and on how well the stator slots are aligned with each other. To provide sufficient push, the feeding force applied via feeder 66 may be up to 50 N although some applications may utilize a higher feeding force to ensure uninterrupted winding of the stator 32.

Once the wire 48 is sufficiently gripped via gripping members 82, the feeder 66 is translated linearly via reciprocation mechanism 70 such that the feeder 66 is moved toward feeder guide 64 as illustrated in FIG. 10. This motion forces the wire 48 through the feeder guide 64 which is aligned with the appropriate needle 50 in the appropriate stator slot 46.

The feeder components 78 are then moved apart to release the gripping members 82 and the feeder 66 is translated linearly via reciprocation mechanism 70 back to the position illustrated in FIG. 8. The wire 48 may then be gripped again via gripping members 82 and the process may be repeated. The feeder 66 is continually operated and reciprocated, as represented by arrow 86, to move the wire 48 through the entire stator housing 42.

The auto feeder 62 on the opposite end of the stator housing 42 is then used to return the wire 48 against the predetermined needle 50 located in the appropriate stator slot 46. This process may be repeated for each successive needle location until the winding of wire 48 is completed. Furthermore, the winding process may be replicated for each corresponding pair of stator slots 46 until the entire stator housing 42 is wound to complete the stator 32. In some applications, the auto feeder 62 positioned at the opposite end of the stator housing 42 may be used to grip and pull the associated needle 50 and/or wire 48 being moved through the corresponding stator slot 46.

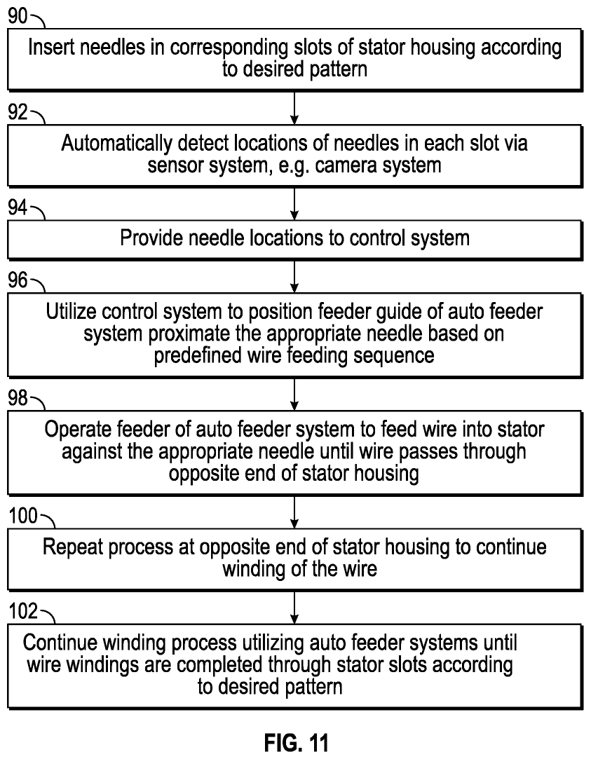

Referring generally to FIG. 11, a flow chart is provided to illustrate one procedural example. In this embodiment, needles 50 are initially inserted into corresponding slots 46 of stator housing 42 according to a desired number and pattern, as represented by flow chart block 90. The sensor/camera system 60 is then moved into position proximate the end of the corresponding stator slot 46 and the locations of the needles 50 are automatically detected, as represented by block 92. The system 60 may be moved into and out of position under the direction of control system 72. The needle location data may then be provided to and stored in the control system 72, as represented by block 94.

Based on this needle location data, the control system 72 utilizes programmed algorithms to position the auto feeder 62, and specifically feeder guide 64, proximate an appropriate needle 50 which is selected based on a predefined wire feeding sequence, as represented by block 96. The control system 72 then automatically operates the feeder 66 to feed the wire 48 against the appropriate needle 50 until the wire 48 passes along the corresponding stator slot 46 and out through the opposite end of the stator housing 42, as represented by block 98.

The end of the wire 48 is then returned to the opposite end of the stator housing 42 (by hand or via automated drum control or other automated mechanism) and the opposite auto feeder 62 is used to repeat the process as the wire 48 is fed back through the stator housing 42, as represented by block 100. This winding process is continued via the auto feeders 62 until the wire windings are completed through the appropriate stator slots 46 according to a desired, preprogrammed pattern, as represented by block 102.

It should be noted, however, that many variations of this procedural example may be utilized depending on the desired use of technicians, level of automation, size of the stator 32, wire size, and other parameters. Furthermore, the methodology may be adapted to fit into various types of production lines and with many different stator types. For example, the methodology may be utilized in winding many sizes of stators used for electric submersible pumping system motors, other types of motors, generators, linear motors, or other types of electric machines.

The programmability of the control system 72 enables automation of wire winding procedures for stators of different sizes and shapes having wires of different dimensions and wound in different winding patterns. The control of components of the auto feeder system 62 may utilize various types of control systems, including CNC type control systems or other processor-based type control systems. Movement of the auto feeder system components may be achieved via motors, hydraulics, pneumatics, and/or other techniques depending on the parameters of anticipated operations and/or environments.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method of preparing windings for an electric machine, comprising:
positioning a plurality of needles in a slot of a stator housing;
detecting the position of each needle in the slot to obtain position data;
providing the position data to a control system;
utilizing the control system to position a magnet wire adjacent a selected needle of the plurality of needles; and
using an auto feeder system, controlled by the control system, to automatically feed the magnet wire against the selected needle and through the slot.

2. The method as recited in claim 1, wherein after the wire is automatically fed through the slot, returning the wire through a corresponding slot of the stator housing.

3. The method as recited in claim 2, wherein utilizing comprises utilizing the control system to position the magnet wire adjacent a second selected needle according to a predefined pattern.

4. The method as recited in claim 3, wherein using comprises using the auto feeder system to automatically feed the magnet wire against the second selected needle and through the slot.

5. The method as recited in claim 4, further comprising utilizing the control system and using the auto feeder system repeatedly until a completed winding of the magnet wire is positioned through the slot and the corresponding slot.

6. The method as recited in claim 1, wherein positioning the plurality of needles comprises positioning at least three needles.

7. The method as recited in claim 1, wherein positioning the plurality of needles comprises positioning at least six needles.

8. The method as recited in claim 1, wherein detecting the position of each needle comprises employing a camera system to detect the positions.

9. The method as recited in claim 1, wherein using the auto feeder system comprises using a feeder guide to move an end of the wire adjacent the selected needle and further using a reciprocating feeder to automatically feed the wire through the feeder guide and the slot.

10. A method, comprising:
mounting a stator housing on a fixture;
positioning an automated feeder system at an end of the stator housing;
using the automated feeder system to feed a magnetic wire longitudinally through the stator housing to facilitate creation of a stator winding; and
automatically controlling the automated feeder system to properly position the magnetic wire prior to feeding the magnetic wire through the stator housing.

11. The method as recited in claim 10, further comprising positioning a plurality of needles in a plurality of stator slots extending longitudinally through the stator housing.

12. The method as recited in claim 11, further comprising using a camera-based sensor system to detect the position of each needle in the slot to obtain position data.

13. The method as recited in claim 12, further comprising providing the position data to a control system.

14. The method as recited in claim 13, further comprising utilizing the control system to position the magnet wire adjacent a selected needle.

15. The method as recited in claim 14, further comprising utilizing the automated feeder system to automatically feed the magnetic wire against the selected needle and to move the magnetic wire through a predetermined slot of the plurality of slots.

16. The method as recited in claim 10, wherein positioning the automated feeder system comprises positioning a pair of the automated feeder systems such that one automated feeder system is positioned at each end of the stator housing.

17. A system to facilitate preparation of windings, comprising:
a camera-based vision system positioned to detect and provide data on the position of needles located in a slot of a stator housing;
an auto feeder having a feeder guide and a feeder, the feeder being able to automatically feed magnet wire through the feeder guide during winding of the stator housing; and
a control system, the control system being programmed to move the feeder guide into proximity with selected needles according to a predefined pattern and to move the feeder to feed the magnet wire once the feeder guide is properly aligned with each selected needle.

18. The system as recited in claim 17, wherein the feeder moves in a reciprocating manner when feeding the magnet wire.

19. The system as recited in claim 18, wherein the feeder comprises gripping members to repeatedly grip and release the magnet wire during feeding of the magnet wire.

20. The system as recited in claim 17, wherein the control system is a processor-based control system.
